(19) United States
(12) Patent Application Publication
(10) Pub. No.: US 2013/0302589 A1
(43) Pub. Date: Nov. 14, 2013

(54) SOFT PAD FOR VEHICLE AND MANUFACTURING METHOD THEREOF

(71) Applicants: HYUNDAI MOTOR COMPANY, Seoul (KR); KIA MOTORS CORP., Seoul (KR)

(72) Inventor: Byung Seok KONG, Gunpo-si (KR)

(73) Assignees: Kia Motors Corp., Seoul (KR); Hyundai Motor Company, Seoul (KR)

(21) Appl. No.: 13/714,972

(22) Filed: Dec. 14, 2012

(30) Foreign Application Priority Data
May 11, 2012 (KR) 10-2012-0050012

(51) Int. Cl. B32B 5/32

(52) U.S. Cl. CPC B32B 5/32
USPC 428/316.6; 264/46.4

(57) ABSTRACT

A soft pad for a vehicle includes: a outermost skin layer; a soft foam layer of the lower part of the skin layer; a protective foam layer, which is united to the lower part of the soft foam layer, and protects the soft foam layer from heat and pressure at the time of molding by being attached to the lower part of the soft foam layer after being manufactured by compression at high temperature and high pressure; and a resin pad layer, which is injected to the lower part of the protective foam layer and united thereto, and a manufacturing method thereof.

The present application claims priority of Korean Patent Application Number 10-2012-0050012 filed May 11, 2012, the entire contents of which application is incorporated herein for all purposes by this reference.

### BACKGROUND OF INVENTION

1. Field of Invention

The present invention relates to a soft pad for a vehicle in order to minimize foam damage when applying a low density foam, to prevent local product defect and to maximize recovery rate, in manufacturing a soft foam-skin integrated crash pad using injection molding; and a manufacturing method thereof.

2. Description of Related Art

FIG. 1 is a drawing showing injection molding of the soft pad according to the related art, FIG. 2 is a drawing showing the press-down phenomenon of the soft foam of the soft pad illustrated in FIG. 1, and FIG. 3 is a drawing showing a section of the soft pad illustrated in FIG. 1.

Conventionally, when a soft foam is applied to a pad such as a crash pad of a vehicle to enhance the shift feeling of a user, there are many cases that the soft foam, which is weak at heat and pressure, is locally pressed down or wrinkled at the time of molding and therefore the outer appearance of the product is not properly formed.

Thus, when the lower density foam is used rather than a foam for integrated injection to enhance the soft feeling, there is a problem of excess soft foam damage. As illustrated in FIG. 1, when a skin 11 and a soft foam 12 are arranged on one mold 10 and a pad resin 24 is discharged through gates 22 in the other mold 20 at the time of manufacturing a soft pad, there is a problem that the thickness of the soft foam 12 is uneven by compression of both molds 10, 20 at the time of molding as shown in FIG. 2. This phenomenon is also found through the sectional drawing of FIG. 3, and therefore, a technique, which can solve the problem of uneven thickness of the soft foam, is needed.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems. Various aspects of the present invention provide for a soft pad for a vehicle in order to minimize foam damage when applying a low density foam, to make thickness evenly and to maximize recovery rate, and a manufacturing method thereof.

Various aspects of the present invention provide for soft pad for a vehicle including: a outermost skin layer; a soft foam layer of the lower part of the skin layer; a protective foam layer, which is united to the lower part of the soft foam layer, and protects the soft foam layer from heat and pressure at the time of molding by being attached to the lower part of the soft foam layer after being manufactured by compression at high temperature and high pressure; and a resin pad layer, which is injected to the lower part of the protective foam layer and united thereto.

The protective foam layer may be made of a material containing high melt strength polypropylene.

The protective foam layer may be manufactured by being compressed under the condition of pressure and temperature applied at the time of injection of the resin pad layer.

The soft foam layer and the protective foam layer may be attached to each other by thermal bonding.

The resin pad layer may be injection molded by being discharged to the lower part of the protective foam layer through plural mold gates followed by being compressed.

The soft pad for a vehicle may be a crash pad of a vehicle.

Various aspects of the present invention provide for a method for manufacturing the soft pad for a vehicle including: a positioning step of positioning an outer jacket including a skin layer, a soft foam layer and a protective layer, which is attached to the lower part of the soft foam layer after being manufactured by compression at high temperature and high pressure, to one mold; a discharging step of discharging a resin pad layer to the protective foam layer through a gate arranged in the other mold; and a compressing step of discharging the resin pad layer followed by compressing thereof.

Herein, the positioning step may include: a preparing step of forming the soft foam layer at the lower part of the skin layer; a forming step of manufacturing the protective foam layer by compressing thereof at high temperature and high pressure; and an attaching step of attaching the protective foam layer to the lower part of the soft foam layer.

In the forming step, the protective foam layer may be manufactured by compressing thereof under the condition of temperature and pressure of the compressing step.

In the forming step, the protective foam layer may be manufactured with a material containing high melt strength polypropylene.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a drawing showing injection molding of the soft pad according to the related art;

FIG. 2 is a drawing showing the press-down phenomenon of the soft foam of the soft pad illustrated in FIG. 1;

FIG. 3 is a drawing showing a section of the soft pad illustrated in FIG. 1;

FIG. 4 is a drawing showing an exemplary process for manufacturing a soft pad according to the present invention; and

FIG. 5 is a flow chart about a manufacturing method of the soft pad illustrated in FIG. 4.

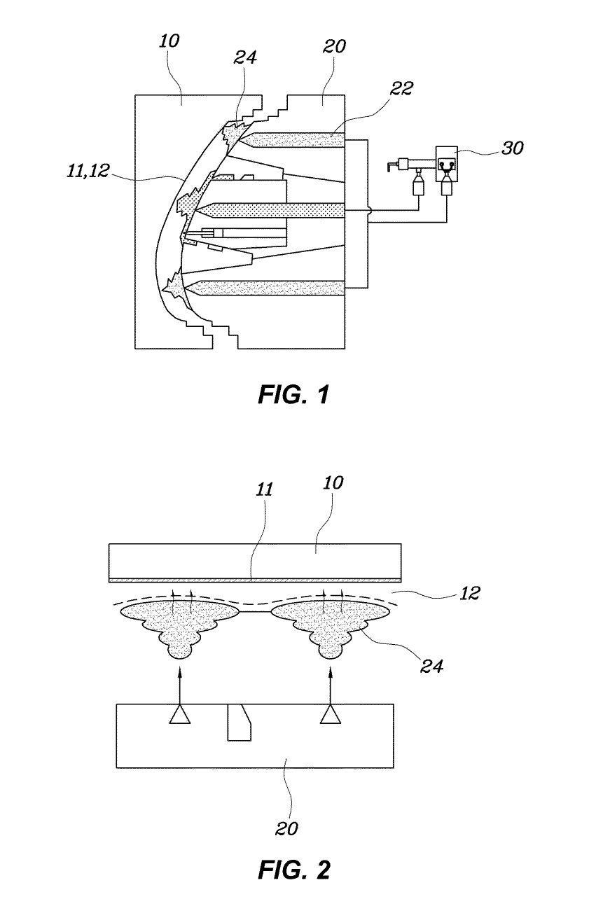

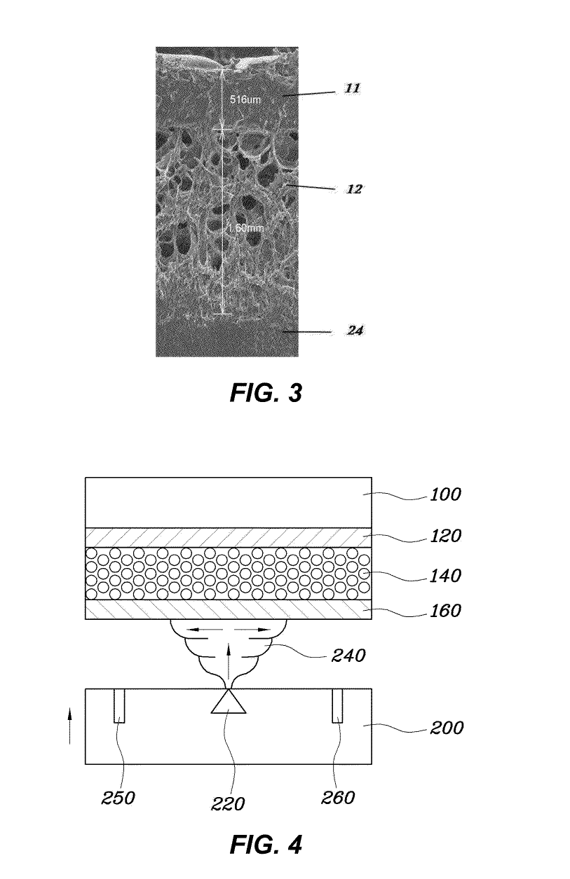

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

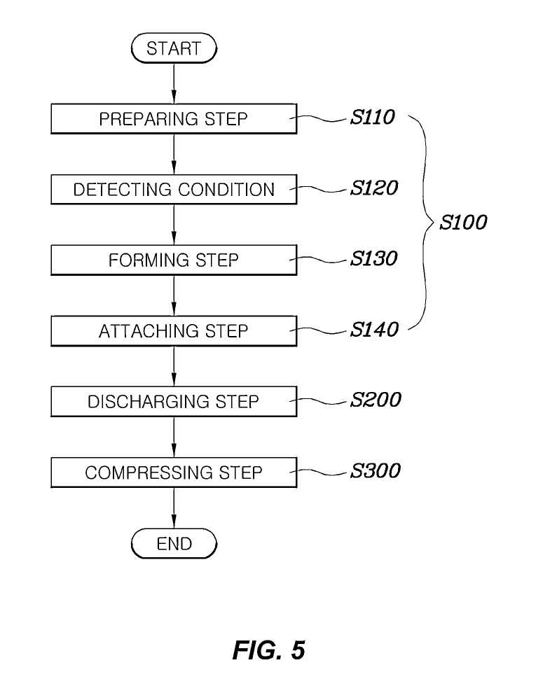

FIG. 4 is a drawing showing a process for manufacturing a soft pad according to various embodiments of the present invention, and FIG. 5 is a flow chart about a manufacturing method of the soft pad illustrated in FIG. 4.

The soft pad of the present invention includes: the outermost skin layer 120; a soft foam layer 140 of the lower part of the skin layer 120; a protective foam layer 160, which is united to the lower part of the soft foam layer 140, and protects the soft foam layer 140 from heat and pressure at the time of molding by being attached to the lower part of the soft foam layer 140 after being manufactured by compression at high temperature and high pressure; and a resin pad layer 240, which is injected to the lower part of the protective foam layer 160 and united thereto.

Namely, the skin layer 120, the soft foam layer 140 and the protective foam layer 160 are laminated in turn to one mold 100, and then the resin pad layer 240 is discharged or molded in situ to the protective foam layer 160 followed by compressing the mold for injection molding. Thus, when the protective foam layer 160 is applied, a problem of uneven thickness of the soft foam 140 may be improved by the protective foam layer 160 blocking heat and pressure at the time of discharging the resin pad layer 240.

Further, the protective foam layer 160 is made of a material containing high melt strength polypropylene (containing about 10% or more mass ratio) so as not to be modified easily by heat and pressure. Through this, the soft foam layer is effectively protected even under the forming condition of high temperature and high pressure so as to significantly reduce local defective rate.

On the other hand, the protective foam layer 160 may be manufactured under the condition of pressure and temperature applied at the time of injection of the resin pad layer 240. For example, the foam layer may be monolithically formed with the resin pad layer 240. For this, as illustrated in FIG. 4, a temperature sensor and a pressure sensor are arranged in the mold, the pressure and temperature condition applied at the time of compression are detected after discharging the resin pad layer, and the protective foam layer is manufactured by compressing thereof at the highest pressure and temperature of the detected condition.

As a result, the protective foam layer is not modified even under the high temperature and high pressure condition applied to the real protective foam layer later, and therefore, the soft foam layer is effectively protected. This may be considered as a technique that can minimize later damage by experiencing harsh condition first.

On the other hand, the soft foam layer 140 and the protective foam layer 160 may be attached to each other by thermal bonding so as to endure the later high temperature and high pressure condition. Further, the resin pad layer 240 is injection molded by being discharged to the lower part of the protective foam layer 160 through plural mold gates 220 followed by being compressed, and the soft pad for a vehicle is very suitable for a crash pad of a vehicle. This crash pad is to maintain the soft feeling of the outer jacket thereof and to support durability firmly inside thereof.

Furthermore, according to the present invention, the bottom damage of the inside of the outer jacket is minimized and also the soft feeling of the product is evenly distributed all around, and as a result, the value of the product can be improved.

On the other hand, the method for manufacturing the soft pad includes: a positioning step S100 of positioning an outer jacket including a skin layer 120, a soft foam layer 140 and a protective layer 160, which is attached to the lower part of the soft foam layer 140 after being manufactured by compression at high temperature and high pressure, to one mold 100; a discharging step S200 of discharging a resin pad layer 240 to the protective foam layer 160 through a gate 220 arranged in the other mold 200; and a compressing step S300 of discharging the resin pad layer 240 followed by compressing thereof.

Herein, the positioning step S100 may include: a preparing step S110 of forming the soft foam layer 140 at the lower part of the skin layer 120; a forming step S130 of manufacturing the protective foam layer 160 by compressing thereof at high temperature and high pressure; and an attaching step S140 of attaching the protective foam layer 160 to the lower part of the soft foam layer 140.

Namely, first of all, the skin layer and the soft foam layer are united, and then the protective foam layer is pressure molded under the high temperature and high pressure condition followed by fixing thereof to the lower part of the soft foam layer by thermal bonding. And more specifically, the forming step S130 is to manufacture the protective foam layer by compressing thereof under the condition of temperature and pressure of the compressing step S300 so as to minimize the later damage of the protective foam layer by experiencing the harsh condition first. For this, the pressure and the temperature generated at the surface of the soft foam layer inside the mold may be detected S120 when compressing the real resin pad layer before forming the protective foam layer, and then the protective foam layer may be manufactured by setting operation condition at the highest values of the pressure and the temperature.

On the other hand, in the forming step S130, the protective foam layer 160 is manufactured with a material containing high melt strength polypropylene so as to effectively protect the soft foam layer under the high temperature and high pressure condition.

According to the soft pad for a vehicle and the manufacturing method thereof as described above, the damage caused by local pressure and heat added to the soft foam at the time of integral molding by applying the protective foam layer, which is made of a material containing high melt strength polypropylene, to the lower part of the soft foam can be minimized. Accordingly, similar soft feeling can be obtained all around the soft foam layer, and local cave-in inside by a manufacturing process or use may be prevented.

Further, in order to maintain the value of the product of the lower part of the soft foam by pressure and heat identically in an integral molding process, molding of the protective form is conducted under the same condition of molding the real resin pad layer, and therefore, influence can be minimized.

For convenience in explanation and accurate definition in the appended claims, the terms lower and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A soft pad for a vehicle comprising:
an outermost skin layer;
a soft foam layer formed at of as lower part of the outermost skin layer;
a protective foam layer, which is united to a lower part of the soft foam layer, and protects the soft foam layer from heat and pressure during subsequent molding by being attached to the lower part of the soft foam layer after being formed by compression at high temperature and high pressure; and
a resin pad layer, which is injected to a lower part of the protective foam layer and united thereto.

2. The soft pad for a vehicle of claim 1, wherein the protective foam layer is made of a material containing high melt strength polypropylene.

3. The soft pad for a vehicle of claim 1, wherein the protective foam layer is manufactured by being compressed under the condition of pressure and temperature applied at the time of injection of the resin pad layer.

4. The soft pad for a vehicle of claim 1, wherein the soft foam layer and the protective foam layer are attached to each other by thermal bonding.

5. The soft pad for a vehicle of claim 1, wherein the resin pad layer is injection molded by being discharged to the lower part of the protective foam layer through plural mold gates followed by being compressed.

6. The soft pad for a vehicle of claim 1, which is a crash pad of a vehicle.

7. A method for manufacturing a soft pad for a vehicle comprising:
a positioning step of positioning an outer jacket comprising a skin layer, a soft foam layer and a protective layer, which is attached to a lower part of the soft foam layer after being formed by compression at high temperature and high pressure, to one mold;
a discharging step of discharging a resin pad layer to the protective foam layer through a gate arranged in the other mold; and
a compressing step of discharging the resin pad layer followed by compressing thereof.

8. The method for manufacturing a soft pad for a vehicle of claim 7, wherein the positioning step comprises:
a preparing step of forming the soft foam layer at the lower part of the skin layer;
a forming step of manufacturing the protective foam layer by compressing thereof at high temperature and high pressure; and
an attaching step of attaching the protective foam layer to the lower part of the soft foam layer.

9. The method for manufacturing a soft pad for a vehicle of claim 8, wherein the forming step is to manufacture the protective foam layer by compressing thereof under the condition of temperature and pressure of the compressing step.

10. The method for manufacturing a soft pad for a vehicle of claim 8, wherein the forming step is to manufacture the protective foam layer with a material containing high melt strength polypropylene.
